(19) United States
(12) Patent Application Publication
(10) Pub. No.: US 2008/0114150 A1
(43) Pub. Date: May 15, 2008

(54) Catalytic conversion of carbonyl type compounds, including amides and others, to methyl ether polymers, substituted methyl ether polymers and methyl ether ladder polymers

(75) Inventor: M. K. Carter, Lincoln, CA (US)

Correspondence Address: Carter Technologies, 2300 Sutter View Lane, Lincoln, CA, 95648, US

(73) Assignee: Carter Technologies, Lincoln, CA (US)

(21) Appl. No.: 11/598,031

(22) Filed: Nov. 13, 2006

(51) Int. Cl. C08G 69/08; C08G 75/00

(52) U.S. Cl. 528/332; 528/390

(57) ABSTRACT

Catalytic processes have been developed for direct chemical conversion of aqueous carbonyl type compounds including amides, sulfoxides and related carbonyl type compounds to methyl ether polymers, substituted methyl ether polymers and/or substituted methyl ether ladder polymers. Amide and sulfoxide carbonyl type compounds including DMF, DMAc, MBAc, MEHx, amides prepared from an organic acid including serine, arginine, histidine and related amino acids, reacted with amines including monoethanolamine, butylamines, methylpropylamines and related amines and DMSO have been polymerized in an aqueous environment to methyl ether polymers, substituted methyl ether polymers or substituted methyl ether ladder polymers by this catalytic process. The catalysts are based on molecular strings of mono-, di- and tri-valent transition metal compounds. Laboratory results have demonstrated [cobalt(II)]₂, [manganese(II)]2, cobalt(II)-manganese(II), [cobalt(III)]₂ and related families of catalysts to be effective for formation of methyl ether polymers, substituted methyl ether polymers or substituted methyl ether ladder polymers by this process.

### REFERENCE CITED

U.S. Patent Documents

| Patent No. | Issue Date | Author | Description |
|---|---|---|---|
| 5,426,242 | Jun. 20, 1995 | JR Moxey | two step process for pre- |
| | | | paring polyethers from |
| | | | diols, such as 1,6- |
| | | | heptanediol, and ethylene |
| | | | oxide in boron trifluoride |
| 5,180,856 | Jan. 19, 1993 | M Stehr and | polyethers from tetra- |
| | | H-W Voges | hydrofuran, alkanols and |
| | | | glycidyl ether in boron |
| | | | trifluoride etherate |
| 5,143,998 | Sep. 1, 1992 | D Brennan, | prepared functionalized |
| | | A Haag, and | amide-ether polymers from |
| | | J White | diglycidyl ether of 4,4′- |
| | | | isopropylidene bisphenol |
| | | | and α, α′-bis |
| 4,978,805 | Dec. 18, 1990 | R Baur, | converted epichlorohydrin |
| | | S Birnbach, | and ethylene oxide to poly- |
| | | A Oftring and | ethers in strong inorganic |
| | | E Winkler | base |
| 4,946,890 | Aug. 7, 1990 | M Meador | prepared ladder polymers |
| | | | from 1,4,5,8-tetrahydro- |
| | | | 1,4,5,8-diepoxyanthracene |
| | | | and a bis-diene |

### BACKGROUND

1. Field of Invention

This invention relates to a catalytic chemical process for conversion of carbonyl type compounds including amides and sulfoxides to methyl ether polymers, substituted methyl ether polymers and/or substituted methyl ether ladder polymers in an aqueous environment. Liquid reactants are typically heated to just below the boiling point in the presence of a mono-, di- or, in some cases, a tri-valent transition metal catalyst to effect polymerization. Polymerization occurs as a result of the catalyst causing a carbonyl type double bond to open, react with a neighbor reactant and continue until the reaction has been completed.

2. Description of Prior Art

A search of the prior art in categories including polyethers, polymers formed from amides and ladder polymer formation did not disclose similar catalytic chemical reaction processes. Prior art discloses U.S. Pat. No. 5,426,242 issued to J R Moxey on Jun. 20, 1995 that teaches a two step process for preparing polyethers from diols, such as 1,6-heptanediol, and ethylene oxide in the presence of potassium hydroxide or a Lewis acid such as boron trifluoride at elevated temperature. U.S. Pat. No. 5,180,856 issued to M Stehr and H-W Voges on Jan. 19, 1993 describes formation of polyethers from tetrahydrofuran, alkanols and glycidyl ether in the presence of boron trifluoride etherate at elevated temperature. R Baur, S Birnbach, A Oftring and E Winkler were issued U.S. Pat. No. 4,978,805 issued on Dec. 18, 1990 describing conversion of epichlorohydrin and ethylene oxide to polyethers in strong inorganic base. These polyether amides contain ethylene oxide and longer carbon group alkylene oxide bonding.

An article entitled, Polyaldol Condensation of Acetaldehyde by Transition Metal Alkyls, by T. Yamamoto. S. Konogaya and A. Yamamoto published in Journal of Polymer Science: Polymer Letters Volume 16, Issue 1, pages 7-12, 2003, disclosed formation of cyclic methyl ether, propyl ether compounds using anhydrous transition metal alkyls under vacuum. These compounds are unstable in an aqueous environment as taught in the present application and immediately decompose to yield no useful products.

U.S. Pat. No. 5,143,998 issued to J D Brennan, A Haag, and J White on Sep. 1, 1992 teaches preparation of functionalized amide-ether polymers from diglycidyl ether of 4,4′-isopropylidene bisphenol and α,α′-bis(4-hydroxybenzamido)-1,3-xylene. Here again these polyether amides contain ethylene oxide and longer alkylene oxide bonding functions.

The methyl ether polymers described as taught herein are quite different from those described above. These polymers are distinguished from repeating ethyl ether, propyl ether and other alkyl or aryl ether polymeric compounds disclosed previously as they comprise repeating [—C(R)(NR′R″)—O—]ₓ units. They are formed by catalytic action in an aqueous system where a carbonyl type double bond is opened to form methyl polyethers with little or no residual carbonyl bonding. Said polyethers possess chemical bonding different from the ethyl, propyl and longer polyethers described above as exhibited by characteristic FTIR intense absorption bands in the 1180 to 1080 cm⁻¹ and 790 to 680 cm⁻¹ regions.

A review of prior art for formation of ladder polymers discloses U.S. Pat. No. 4,946,890 issued to M Meador on Aug. 7, 1990 that teaches a process for preparation of ladder polymers from 1,4,5,8-tetrahydro-1,4,5,8-diepoxyanthracene and a bis-diene.

Methyl ether ladder polymers as taught herein are quite different again from polyethers described in previous patent literature in that they comprise a pair of parallel repeating (—C—O—)ₓ molecular units separated by cross links comprising —CH═CH— or —CR═CR—. They are formed by catalytic action where an amide, sulfoxide or related carbonyl type double bond is opened in an aqueous environment to form substituted methyl polyethers. Said polyethers possess chemical bonding quite different from the polyethers described in prior patent literature as exhibited by characteristic FTIR intense absorption bands in the 1465 to 1395 cm⁻¹ region plus two of the following three absorptions dependent on chemical bonding, in the 880 to 870 cm⁻¹, 750 to 705 cm⁻¹ and 490 to 475 cm⁻¹ regions.

### SUMMARY OF THE INVENTION

This invention describes an aqueous catalytic chemical process for conversion of carbonyl type compounds including amides and sulfoxides to methyl ether polymers, substituted methyl ether polymers and/or substituted methyl ether ladder polymers. A broad range of strings of mono-, di- and, in some cases, tri-valent transition metal catalysts with inorganic sulfate and other co-catalysts facilitate conversion to methyl polyethers. These are different from ethylene glycol and other alkenol polyethers as the properties of the polymers disclosed herein are dry and tough compared to polyethylene glycol polymers that exhibit wax-like properties.

It is an object of this invention, therefore, to provide a mono-metal or string transition metal catalytic process facilitating conversion of amides, sulfoxides and related carbonyl-type compounds to methyl ether polymers, substituted methyl ether polymers or substituted methyl ether ladder polymers. Other objects of this invention will be apparent from the detailed description thereof which follows, and from the claims.

### DETAILED DESCRIPTION OF THE INVENTION

A process for aqueous catalytic chemical conversion of carbonyl type compounds including amides, sulfoxides and related carbonyl type compounds to methyl ether polymers, substituted methyl ether polymers or substituted methyl ether ladder polymers is taught. These polymers are distinguished from repeating ethyl ether, propyl ether and other alkyl ether polymeric compounds disclosed previously as they comprise repeating [—C(R)(NR′R″)—O—]ₓ units. Repeating ethyl ether linkages such as polyethylene glycols found in the prior art are characterized by weak to moderately strong infrared spectral absorption in the 1150 to 1060 cm⁻¹ range (L. J. Bellamy, “The Infrared Spectra of Complex Molecules”, volume I, chapter 7, page 131, 3^{rd} edition, Chapman and Hall, published 1986) where as repeating methyl ether polymers disclosed in this application are characterized by intense infrared spectral absorption in the 1200 to 1100 cm⁻¹, 800 to 670 cm⁻¹ and 624 to 594 cm⁻¹ regions. A broad range of individual as well as strings of mono-, di- or tri-valent metal catalysts based on mono-metal and other transition metal compounds, such as [vanadium(II)]₂, [cobalt(II)]₂, [chromium(II)]₂ and similar type compounds, for which the transition metals and directly attached atoms possess C₄ᵥ, D₄ₕ or D_{2d} point group symmetry. These catalysts have been designed based on a formal theory of catalysis, Concepts of Catalysis, and the catalysts have been produced, and tested to prove their activity. The theory of catalysis rests upon a requirement that a catalyst possess a single metal atom or a molecular string of transition metal atoms such that electronic transitions from one molecular electronic configuration to another be barrier free so reactants may proceed freely to products as driven by thermodynamic considerations. Catalysts effective for chemical conversion of amides, sulfoxides and related carbonyl type compounds to products comprise mono-metal, di-metal, tri-metal and/or poly-metal backbone or molecular string type compounds of the transition metals comprising titanium, vanadium, chromium, manganese, iron, cobalt, nickel, copper, zirconium, niobium, molybdenum, ruthenium, rhodium, palladium, silver, hafnium, tantalum, tungsten, rhenium, technetium, osmium, iridium, platinum, gold or combinations thereof in addition to co-catalysts. Co-catalysts comprise Li₂SO₄, Na₂SO₄, K₂SO₄, CaSO₄, BaSO₄, other sulfates, phosphates, nitrates and borates and other similar compounds.

Methyl ether ladder polymers as taught herein are quite different again from polyethers described in previous patent literature in that they comprise a pair of parallel repeating (—C—O—)ₓ molecular units separated by cross links comprising —CH═CH— or —CR═CR— and others. They are formed by catalytic action using triplet type transition metal pairs comprising a type of [cobalt(III)-cobalt(III)], [manganese(III)-manganese(III)] or similar compounds transition metal complexes in an aqueous environment where an amide, sulfoxide or related carbonyl type double bond is opened to form methyl polyethers with little or no residual carbonyl bonding. Said polyethers possess chemical bonding quite different from the polyethers described in prior patent literature as exhibited by characteristic FTIR intense absorption bands in the 1465 to 1395 cm⁻¹ region plus two of the following three absorptions dependant on chemical bonding, 880 to 870 cm⁻¹, 750 to 705 cm⁻¹ and 490 to 475 cm⁻¹ regions.

Amides, sulfoxides and related carbonyl type compounds comprising DMF, DMAc, MBAc, MEHx, amides prepared from aqueous solutions of organic acids comprising serine, arginine and histidine, reacted with amines comprising monoethanolamine, butylamines, methylpropylamines and DMSO are polymerized by mono, divalent and a few trivalent transition metal compounds. Said amides and related carbonyl type compounds are polymerized to ladder polymers near ambient temperature or by heating below their boiling temperatures in the presence of a catalyst.

### Catalyst Selection Considerations

The Concepts of Catalysis effort forms a basis for selecting molecular catalysts for specified chemical reactions through computational methods by means of the following six process steps. An acceptable polymerization mechanism, involving a pair of metal atoms, was established for carbonyl compounds in the presence of water (step 1). A specific transition metal, such as cobalt, was selected as a possible catalytic site as found in an M-M or Co—Co string (step 2), for one metal atom bonded with two to four reactant carbonyl type molecules in a C₄ᵥ, D₄ₕ or D_{2d} point group symmetry configuration, and having a computed bonding energy to the associated reactants of less than −60 kcal/mol (step 3). The first valence state for which the energy values were two-fold degenerate was 2+ (step 4), although triplet type compounds may be employed with valence of +3. Sulfate, phosphate and other anions may be chosen provided they are chemically compatible with the metal, M or Co, in formation of the catalyst (step 5). A test should also be conducted to establish compliance with the rule of 18 (or 32) to stabilize the catalyst so compatible ligands may be added to complete the coordination shell (step 6). This same process may be applied for selection of a catalyst using any of the first, second or third row transition metals, however, only those with acceptable negative bonding energies can produce effective catalysts. The approximate relative bonding energy values may be computed using a semi-empirical algorithm. This computational method indicated that any of the first row transition metal complexes can produce usable catalysts once the outer coordination shell had been completed with ligands, even though the elements V, Cr, Mn, Fe, Co and Cu indicated more reasonable bonding energies in a simplified molecular model. Second row and third row transition metal complexes are also indicated to produce active polymerization catalysts. In general, preliminary energy values computed for transition metal complexes are indicated to produce useable catalysts once bonding ligands have been added.

### Description of Catalyst Preparation And Polymerization

### EXAMPLE 1

Preparation of the Co(O₂CR)₂L.Co(O₂CR)₂L catalyst, for L being CaSO₄, was conducted by the above process. To 0.0249 gram (0.1 mmol) of cobalt (II) acetate tetrahydrate was added 0.0569 gram (0.2 mmol) of stearic acid, 1.0 gram of calcium sulfate and 0.4 gram of pure water. The mixture was heated to approximately 100° C. for two minutes to form the catalyst.

### EXAMPLE 2

Preparation of the Cr(O₂CR)₂L.Cr(O₂CR)₂L catalyst, for L being Li₂SO₄, was conducted in a similar fashion. To 0.0158 gram (0.1 mmol) of chromium (III) chloride was added 0.0569 gram (0.2 mmol) of stearic acid, 1.0 gram of lithium sulfate, 0.065 gram of zinc dust and 0.4 gram of pure water. The mixture was heated to approximately 100° C. for two minutes to form the catalyst.

### EXAMPLE 3

Preparation of the V(O₂CR)₂L.V(O₂CR)₂L catalyst, for L being K₂SO₄, was conducted by a process similar to that described above. To 0.0182 gram (0.1 mmol) of vanadium pentoxide was added 0.0569 gram (0.2 mmol) of stearic acid, 1.0 gram of potassium sulfate and 0.4 gram of pure water. The mixture was heated to approximately 100° C. for two minutes to form the catalyst. The mixture turned colorless as the reduced valance vanadium formed at the beginning of the reaction.

### EXAMPLE 4

Preparation of the Co₂(C₆Cl₄O₂)₃[C₆Cl₄(OH)₂] catalyst was conducted as follows. To 0.0267 gram (0.1 mmol) of Co(NH₃)₆Cl₃ dissolved in 2 mL of pure water was added 0.0496 gram (0.2 mmol) of tetrachlorocatechol dissolved in 2 to 4 grams of a heated ethanol acetone mixture. The mixture was heated for two to four minutes to form a dark brown catalyst complex.

### Catalytic Polymerization

### Preparation 1

To the aqueous catalyst solution in example 1, contained in a 25 mL glass vial, was added 1.00 gram of glacial acetic acid and 1.01 gram of ethanolamine to form an amide when heated. A screw cap was closed and then opened slightly to allow water vapor to vent. The vial was rapidly heated to 200° C. and heating continued in the 190° C. to 200° C. for four hours. The liquid became solid after approximately one half hour as product formed. After four hours the vial was cooled and opened to isolate the polymer.

### Preparation 2

To the aqueous catalyst solution in example 2, contained in a 25 mL glass vial, was added 1.00 gram of glacial acetic acid and 1.22 gram of n-butylamine to form an amide when heated. A screw cap was closed and then opened slightly to allow water vapor to vent. The vial was rapidly heated to 200° C. and heating continued in the 190° C. to 200° C. for four hours. The liquid became solid after four hours the vial was cooled and opened to isolate the polymer.

### Preparation 3

To the aqueous catalyst solution in example 3, contained in a 5 mL glass pressure vial, was added 2.00 grams of DMAc and a drop of pure water. The pressure vial was sealed, flushed with nitrogen, rapidly heated to 210° C. and heating continued in the 210° C. to 220° C. for four hours. After four hours the vial was cooled, residual pressure released and opened to isolate the polymer.

### Preparation 4

To the aqueous catalyst solution in example 4, contained in a 25 mL glass pressure vial, was added 4.00 grams of DMAc. The vial was warmed to 20° C. to 45° C. and maintained in this temperature range for several days. After several days the vial was opened to isolate the crystalline needle polymer.

What is claimed:

1. A catalytic process for conversion of carbonyl type compounds comprising amides and sulfoxides to polymers comprising methyl ether polymers, substituted methyl ether polymers and/or substituted methyl ether ladder polymers in an aqueous environment.

2. A catalytic process for conversion of carbonyl type compounds comprising amides and sulfoxides to polymers comprising methyl ether polymers, substituted methyl ether polymers and/or substituted methyl ether ladder polymers in an aqueous environment using transition metal catalysts comprising low valence compounds of titanium, vanadium, chromium, manganese, iron, cobalt, nickel, copper, zirconium, hafnium, nobelium, tantalum, molybdenum, tungsten, rhenium, technetium, platinum, palladium, ruthenium, rhodium, osmium, iridium, silver-and-gold, combinations of transition metals comprising manganese-cobalt, iron-cobalt, vanadium-chromium, nickel-copper and others with co-catalysts comprising Li₂SO₄, Na₂SO₄, K₂SO₄, CaSO₄, BaSO₄ and related sulfates, phosphates, nitrates, borates and similar oxygenated anionic compounds.

3. A catalytic process for conversion of compounds comprising DMSO, DMF, DMAc, MBAc, MEHx, amides prepared from organic acids comprising serine, arginine, histidine and related amino acids, reacted with amines comprising monoethanolamine, butylamines, methylpropylamines to polymers comprising methyl ether polymers, substituted methyl ether polymers and/or substituted methyl ether ladder polymers in an aqueous environment.

4. A catalytic process for conversion of compounds comprising DMSO, DMF, DMAc, MBAc, MEHx, amides prepared from organic acids comprising serine, arginine, histidine and related amino acids, reacted with amines comprising monoethanolamine, butylamines, methylpropylamines to polymers comprising methyl ether polymers, substituted methyl ether polymers and/or substituted methyl ether ladder polymers in an aqueous environment using transition metal catalysts comprising low valence compounds of titanium, vanadium, chromium, manganese, iron, cobalt, nickel, copper, zirconium, hafnium, nobelium, tantalum, molybdenum, tungsten, rhenium, technetium, platinum, palladium, ruthenium, rhodium, osmium, iridium, silver and gold, combinations of transition metals comprising manganese-cobalt, iron-cobalt, vanadium-chromium, nickel-copper and others with co-catalysts comprising Li₂SO₄, Na₂SO₄, K₂SO₄, CaSO₄, BaSO₄ and related sulfates, phosphates, nitrates, borates and similar oxygenated anionic compounds.
